(19) United States
(12) Patent Application Publication
(10) Pub. No.: US 2015/0230223 A1
(43) Pub. Date: Aug. 13, 2015

(54) USER EQUIPMENT (UE) AUTONOMOUS SWITCHING OF SIMULTANEOUS PHYSICAL UPLINK SHARED CHANNEL (PUSCH) AND PHYSICAL UPLINK CONTROL CHANNEL (PUCCH) TRANSMISSIONS

(71) Applicant: QUALCOMM Incorporated, San Diego, CA (US)

(72) Inventors: Jose Edson VARGAS BAUTISTA, San Diego, CA (US); Rao Sanyasi YENAMANDRA, San Diego, CA (US)

(73) Assignee: QUALCOMM INCORPORATED, San Diego, CA (US)

(21) Appl. No.: 14/176,668

(22) Filed: Feb. 10, 2014

(51) Int. Cl. H04W 72/04; H04W 28/04; H04W 52/32

(52) U.S. Cl. CPC H04W 72/0406; H04W 52/325; H04W 28/048

(57) ABSTRACT

Certain aspects provide a method for autonomous switching of simultaneous physical uplink shared channel (PUSCH) and physical uplink control channel (PUCCH) transmissions by a user equipment (UE). A method for wireless communications by a UE is provided. The method generally includes determining whether a power limited condition exists and transmitting simultaneously on multiple uplink channels or transmitting on a single uplink channel based on the determination.

### BACKGROUND

I. Field

Certain aspects of the disclosure generally relate to wireless communications and, more particularly, to techniques for autonomous switching of simultaneous physical uplink shared channel (PUSCH) and physical uplink control channel (PUCCH) transmissions by a user equipment (UE).

II. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

### SUMMARY

Certain aspects of the disclosure generally relate to wireless communications and, more particularly, to techniques for autonomous switching of simultaneous physical uplink shared channel (PUSCH) and physical uplink control channel (PUCCH) transmissions by a user equipment (UE).

Certain aspects of the present disclosure provide a method for wireless communications by a user equipment (UE). The method generally includes determining whether a power limited condition exists and transmitting simultaneously on multiple uplink channels or transmitting on a single uplink channel based on the determination.

Certain aspects of the present disclosure provide an apparatus for wireless communications by a user equipment (UE). The apparatus generally includes means for determining whether a power limited condition exists and means for transmitting simultaneously on multiple uplink channels or transmitting on a single uplink channel based on the determination.

Certain aspects of the present disclosure provide an apparatus for wireless at least one processor configured to determine whether a power limited condition exists and transmit simultaneously on multiple uplink channels or transmitting on a single uplink channel based on the determination. The apparatus generally also includes a memory coupled with the at least one processor.

Certain aspects of the present disclosure provide a computer program product for wireless communications. The computer program product generally includes a computer-readable medium having instructions stored thereon, the instructions executable by an apparatus for determining whether a power limited condition exists and transmitting simultaneously on multiple uplink channels or transmitting on a single uplink channel based on the determination.

Various aspects and features of the disclosure are described in further detail below.

### BRIEF DESCRIPTION OF THE DRAWINGS

FIG. 1 is a block diagram conceptually illustrating an example of a wireless communications network, in accordance with certain aspects of the present disclosure.

FIG. 2 is a block diagram conceptually illustrating an example of a frame structure in a wireless communications network, in accordance with certain aspects of the present disclosure.

FIG. 2B shows an example format for the uplink in Long Term Evolution (LTE), in accordance with certain aspects of the present disclosure.

FIG. 3 shows a block diagram conceptually illustrating an example of a Node B in communication with a user equipment device (UE) in a wireless communications network, in accordance with certain aspects of the present disclosure.

FIG. 4 illustrates example operations for wireless communication that may be performed, for example, by a UE, in accordance with certain aspects of the present disclosure.

### DETAILED DESCRIPTION

Techniques are provided herein for autonomous switching of simultaneous physical uplink shared channel (PUSCH) and physical uplink control channel (PUCCH) transmissions by a user equipment (UE).

While examples are describes with reference to machine type devices, the techniques presented herein may be applied to any type of delay tolerant devices and, more generally, to any type of device.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

### Example Wireless Network

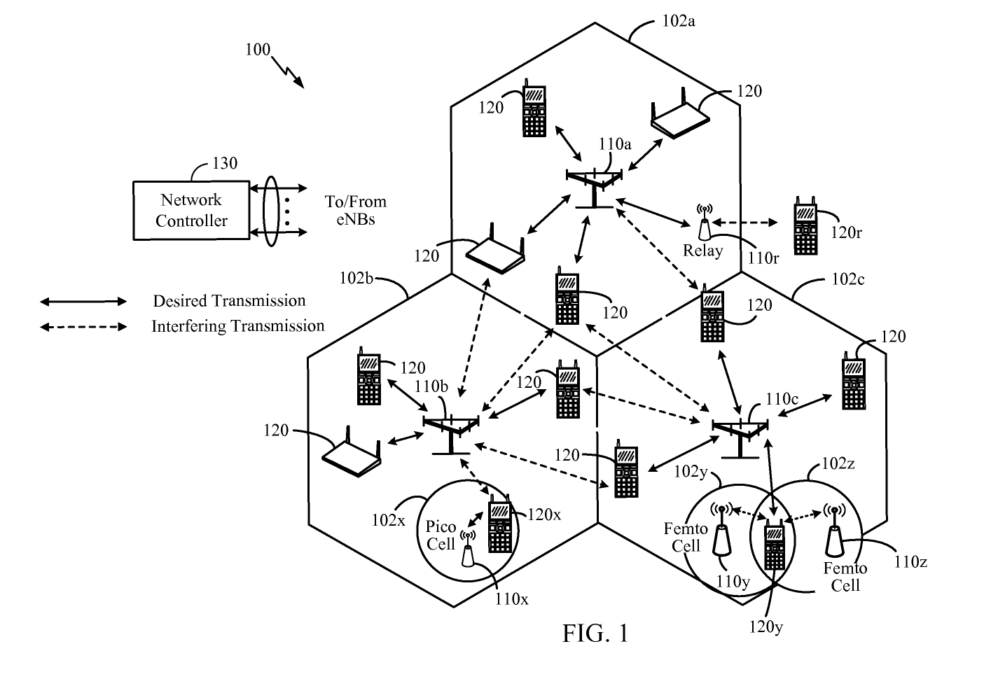

FIG. 1 shows a wireless communication network 100, which may be an LTE network. The wireless network 100 may include a number of evolved Node Bs (eNBs) 110 and other network entities. An eNB may be a station that communicates with user equipment devices (UEs) and may also be referred to as a base station, a Node B, an access point, etc. Each eNB 110 may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB (i.e., a macro base station). An eNB for a pico cell may be referred to as a pico eNB (i.e., a pico base station). An eNB for a femto cell may be referred to as a femto eNB (i.e., a femto base station) or a home eNB. In the example shown in FIG. 1, eNBs 110a, 110b, and 110c may be macro eNBs for macro cells 102a, 102b, and 102c, respectively. eNB 110x may be a pico eNB for a pico cell 102x. eNBs 110y and 110z may be femto eNBs for femto cells 102y and 102z, respectively. An eNB may support one or multiple (e.g., three) cells.

The wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with eNB 110a and a UE 120r in order to facilitate communication between eNB 110a and UE 120r. A relay station may also be referred to as a relay eNB, a relay, etc.

The wireless network 100 may be a heterogeneous network (HetNet) that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 watts) whereas pico eNBs, femto eNBs, and relays may have a lower transmit power level (e.g., 1 watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a tablet, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB. For certain aspects, the UE may comprise an LTE Release 10 UE.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz, and there may be 1, 2, 4, 8, or 16 subbands for system bandwidth of 1.25, 2.5, 5, 10, or 20 MHz, respectively.

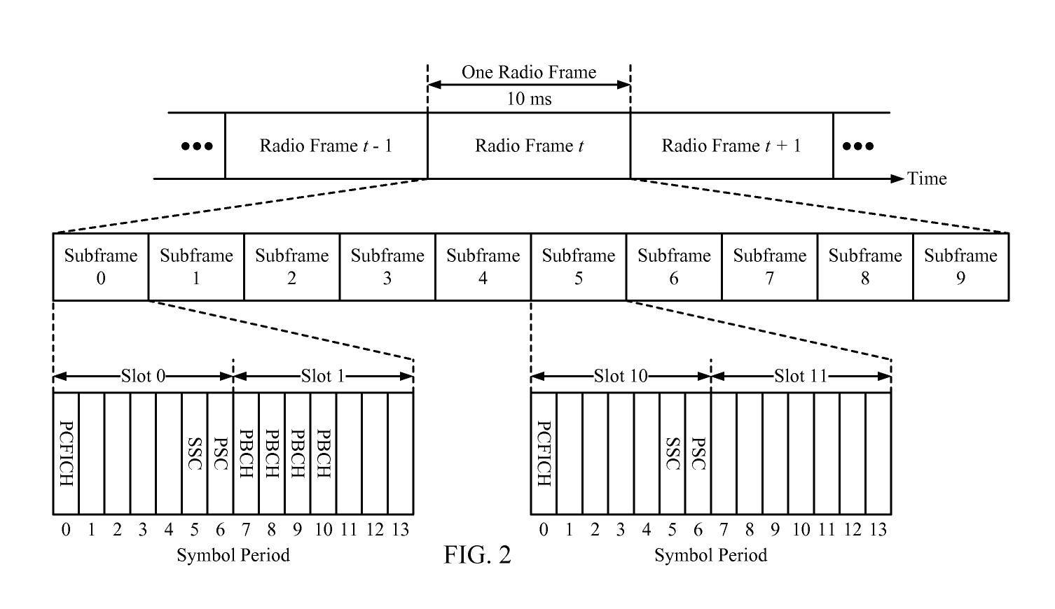

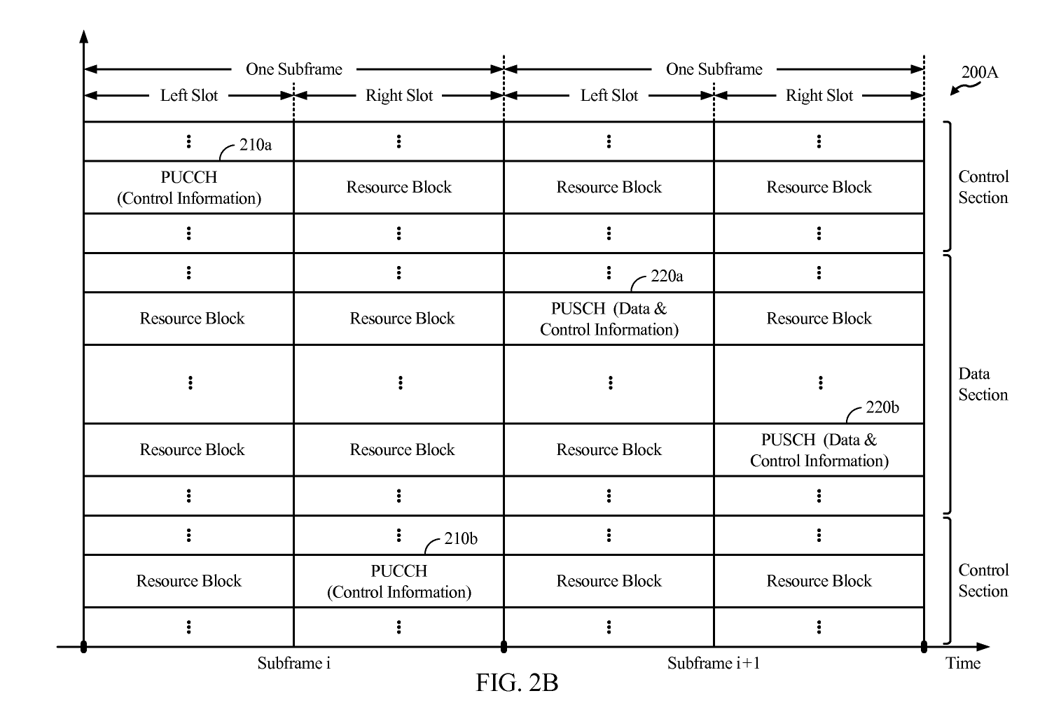

FIG. 2 shows a frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., L=7 symbol periods for a normal cyclic prefix (as shown in FIG. 2) or L=6 symbol periods for an extended cyclic prefix. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as shown in FIG. 2. The PCFICH may convey the number of symbol periods (M) used for control channels, where M may be equal to 1, 2, or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe (not shown in FIG. 2). The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 32, or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

FIG. 2A shows an exemplary format 200A for the uplink in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 2A results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the eNB. The UE may transmit control information in a Physical Uplink Control Channel (PUCCH) 210a, 210b on the assigned resource blocks in the control section. The UE may transmit only data or both data and control information in a Physical Uplink Shared Channel (PUSCH) 220a, 220b on the assigned resource blocks in the data section. An uplink transmission may span both slots of a subframe and may hop across frequency as shown in FIG. 2A.

A UE may be within the coverage of multiple eNBs. One of these eNBs may be selected to serve the UE. The serving eNB may be selected based on various criteria such as received power, pathloss, signal-to-noise ratio (SNR), etc.

A UE may operate in a dominant interference scenario in which the UE may observe high interference from one or more interfering eNBs. A dominant interference scenario may occur due to restricted association. For example, in FIG. 1, UE 120y may be close to femto eNB 110y and may have high received power for eNB 110y. However, UE 120y may not be able to access femto eNB 110y due to restricted association and may then connect to macro eNB 110c with lower received power (as shown in FIG. 1) or to femto eNB 110z also with lower received power (not shown in FIG. 1). UE 120y may then observe high interference from femto eNB 110y on the downlink and may also cause high interference to eNB 110y on the uplink.

A dominant interference scenario may also occur due to range extension, which is a scenario in which a UE connects to an eNB with lower pathloss and lower SNR among all eNBs detected by the UE. For example, in FIG. 1, UE 120x may detect macro eNB 110b and pico eNB 110x and may have lower received power for eNB 110x than eNB 110b. Nevertheless, it may be desirable for UE 120x to connect to pico eNB 110x if the pathloss for eNB 110x is lower than the pathloss for macro eNB 110b. This may result in less interference to the wireless network for a given data rate for UE 120x.

In an aspect, communication in a dominant interference scenario may be supported by having different eNBs operate on different frequency bands. A frequency band is a range of frequencies that may be used for communication and may be given by (i) a center frequency and a bandwidth or (ii) a lower frequency and an upper frequency. A frequency band may also be referred to as a band, a frequency channel, etc. The frequency bands for different eNBs may be selected such that a UE can communicate with a weaker eNB in a dominant interference scenario while allowing a strong eNB to communicate with its UEs. An eNB may be classified as a “weak” eNB or a “strong” eNB based on the received power of signals from the eNB received at a UE (and not based on the transmit power level of the eNB).

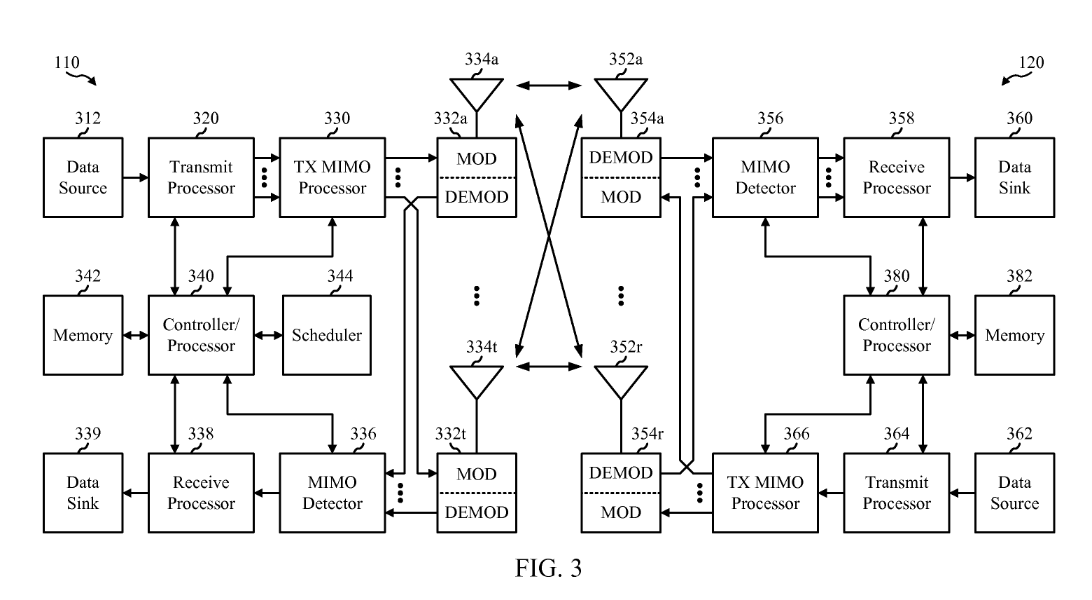

FIG. 3 is a block diagram of a design of a base station or an eNB 110 and a UE 120, which may be one of the base stations/eNBs and one of the UEs in FIG. 1. For a restricted association scenario, the eNB 110 may be macro eNB 110c in FIG. 1, and the UE 120 may be UE 120y. The eNB 110 may also be a base station of some other type. The eNB 110 may be equipped with T antennas 334a through 334t, and the UE 120 may be equipped with R antennas 352a through 352r, where in general T≧1 and R≧1.

At the eNB 110, a transmit processor 320 may receive data from a data source 312 and control information from a controller/processor 340. The control information may be for the PBCH, PCFICH, PHICH, PDCCH, etc. The data may be for the PDSCH, etc. The transmit processor 320 may process (e.g., encode and symbol map) the data and control information to obtain data symbols and control symbols, respectively. The transmit processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide T output symbol streams to T modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. T downlink signals from modulators 332a through 332t may be transmitted via T antennas 334a through 334t, respectively.

At the UE 120, antennas 352a through 352r may receive the downlink signals from the eNB 110 and may provide received signals to demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all R demodulators 354a through 354r, perform MIMO detection on the received symbols, if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from transmit processor 364 may be precoded by a TX MIMO processor 366 if applicable, further processed by modulators 354a through 354r (e.g., for SC-FDM, etc.), and transmitted to the eNB 110. At the eNB 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

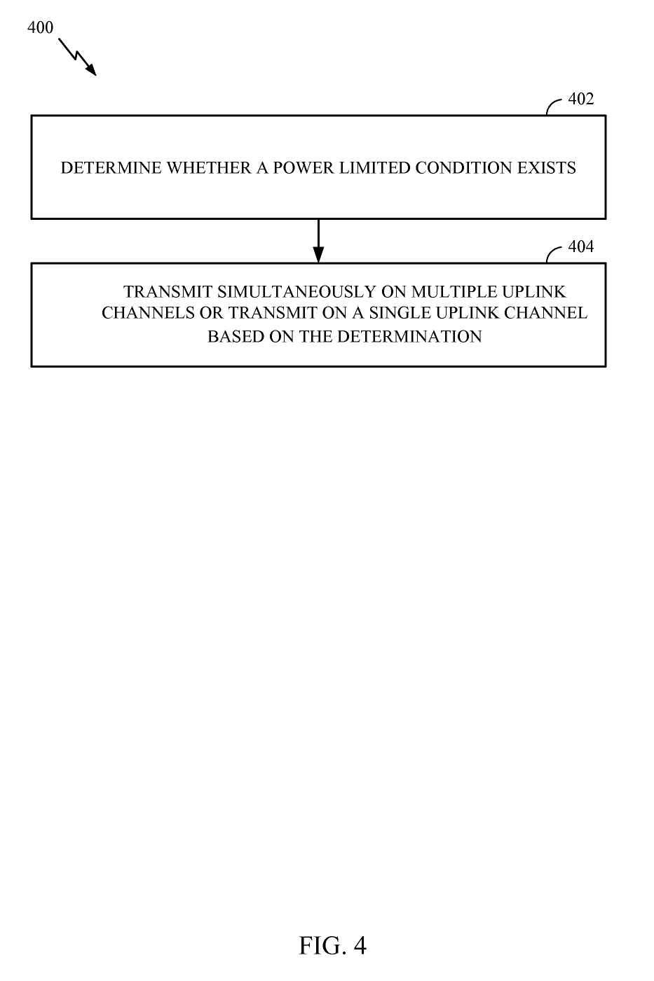

The controllers/processors 340 and 380 may direct the operation at the eNB 110 and the UE 120, respectively. The controller/processor 340, receive processor 338, and/or other processors and modules at the eNB 110 may perform or direct operations 400 in FIG. 4 and/or other processes for the techniques described herein. The memories 342 and 382 may store data and program codes for the eNB 110 and the UE 120, respectively. A scheduler 344 may schedule UEs for data transmission on the downlink and/or uplink.

### Example UE Autonomous Switching of Simultaneous PUSCH and PUCCH Transmissions

In long term evolution (LTE) Release 10, a user equipment (UE) may transmit simultaneously on physical uplink shared channel (PUSCH) and physical uplink control channel (PUCCH). Simultaneously transmitting PUCCH and PUSCH may improve uplink (UL) resource allocation by providing flexibility (e.g., frequency diversity allocation) and also expanding the number of UL resources available in given subframe.

Simultaneous transmission on PUCCH and PUSCH may also allow the UE to maintain UL control information on a Primary control channel concurrently with data on the PUSCH, which may result in better utilization of frequency resources in a given subframe. However, simultaneous transmission on PUSCH and PUCCH may negatively impact UL cubic metric (e.g., peak-to-average power ratio) performance of the UE, especially in situations of UEs with limited UL transmission.

For example, in certain system (e.g., LTE Advanced (LTE-A)) with simultaneous PUSCH and PUCCH transmission, PUCCH may be the preferred channel in terms of power allocation because its power may be allocated first and the remaining UE available power, up to the UE max power, may be allocated to PUSCH. However, in cases where UE power is limited and ACK/NAK are absent, this may result in inefficiencies.

Accordingly, techniques and apparatus for power efficient UE behavior are desirable.

Techniques and apparatus are provided herein that may allow a UE to autonomously switch between simultaneous transmission on PUSCH and PUCCH or a single channel only based on whether the amount of power available to the UE for UL transmissions.

According to certain aspects, if the UE supports simultaneous transmission on PUSCH and PUCCH and acknowledgment (ACK)/negative acknowledgment (NACK) are absent, the UE may determine whether a Power Limited condition exists. For example, the UE may compare available instantaneous power headroom and compare the power headroom availability with the impact on Cubic Metric if simultaneous transmission on PUSCH and PUCCH is allowed. In aspects, if estimated cubic metric deterioration for simultaneous PUCCH and PUSCH is not acceptable, then Periodic CSI may be transmitted on PUSCH instead of PUCCH.

According to certain aspects, an UL power limited condition may be determined, for example, when the UE instantaneous power headroom is below a predefined threshold.

According to certain aspects, the decision to transmit on PUSCH only may be made autonomously by the UE.

Autonomous switching between simultaneous PUSCH/PUCCH transmission and single PUSCH transmission may provide the advantage of better utilization of UL UE transmission, may reduce battery consumption, and may reduce UL interference.

FIG. 4 illustrates example operations 400 for wireless communications, in accordance with certain aspects of the present disclosure. The operations 400 may be performed, for example, by a user equipment (UE) (e.g., 120). The operations 400 may begin, at 402, by determining whether a power limited condition exists, for example, by comparing instantaneous power headroom to a threshold.

At 404, the UE may transmit simultaneously on multiple uplink channels or transmitting on a single uplink channel based on the determination. The uplink channels may comprise physical uplink shared channel (PUSCH) and physical uplink control channel (PUCCH). In aspects, the UE may transmit simultaneously on PUSCH and PUCCH if a power limited condition does not exist and transmits only on PUSCH if a power limited condition exists.

According to certain aspects, the UE may reallocate resources allocated for transmission on the PUCCH to the PUSCH, for example, by reallocating one or more resource blocks (RBs) allocated from transmission on the PUCCH to the PUSCH. In aspects, the transmissions may be periodic channel state information (CSI). According to certain aspects, acknowledgement (ACK) and negative ACK (HACK) are not present.

As used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits and algorithm steps described in connection with the disclosure herein may be implemented as electronic hardware, computer software, or combinations of both. To clearly illustrate this interchangeability of hardware and software, various illustrative components, blocks, modules, circuits and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM or any other form of storage medium known in the art. An exemplary storage medium is coupled to the processor such that the processor can read information from, and/or write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal Generally, where there are operations illustrated in Figures, those operations may have corresponding counterpart means-plus-function components with similar numbering.

In one or more exemplary designs, the functions described may be implemented in hardware, software, firmware or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for wireless communications by a user equipment (UE), comprising:
determining whether a power limited condition exists; and
transmitting simultaneously on multiple uplink channels or transmitting on a single uplink channel based on the determination.

2. The method of claim 1, wherein the uplink channels comprise physical uplink shared channel (PUSCH) and physical uplink control channel (PUCCH).

3. The method of claim 1, wherein transmitting simultaneously on multiple uplink channels or transmitting on a single uplink channel based on the determination comprises:
transmitting simultaneously on physical uplink shared channel (PUSCH) and physical uplink control channel (PUCCH) if a power limited condition does not exist; and
transmitting only on PUSCH if a power limited condition exists.

4. The method of claim 3, further comprising:
reallocating resources allocated for transmission on the PUCCH to the PUSCH.

5. The method of claim 4, wherein reallocating resources allocated to for transmission on the PUCCH to the PUSCH comprises:
reallocating one or more resource blocks (RBs) allocated from transmission on the PUCCH to the PUSCH.

6. The method of claim 1, wherein determining whether a power limited condition exists comprises comparing instantaneous power headroom to a threshold.

7. The method of claim 1, wherein the transmitting comprises transmitting periodic channel state information (CSI).

8. The method of claim 1, wherein acknowledgement (ACK) and negative ACK (NACK) are not present.

9. An apparatus for wireless communications by a user equipment (UE), comprising:
means for determining whether a power limited condition exists; and
means for transmitting simultaneously on multiple uplink channels or transmitting on a single uplink channel based on the determination.

10. The apparatus of claim 9, wherein the uplink channels comprise physical uplink shared channel (PUSCH) and physical uplink control channel (PUCCH).

11. The apparatus of claim 9, wherein transmitting simultaneously on multiple uplink channels or transmitting on a single uplink channel based on the determination comprises:
transmitting simultaneously on physical uplink shared channel (PUSCH) and physical uplink control channel (PUCCH) if a power limited condition does not exist; and
transmitting only on PUSCH if a power limited condition exists.

12. The apparatus of claim 11, further comprising:
means for reallocating resources allocated for transmission on the PUCCH to the PUSCH.

13. The apparatus of claim 12, wherein reallocating resources allocated to for transmission on the PUCCH to the PUSCH comprises:
reallocating one or more resource blocks (RBs) allocated from transmission on the PUCCH to the PUSCH.

14. The apparatus of claim 9, wherein determining whether a power limited condition exists comprises comparing instantaneous power headroom to a threshold.

15. The apparatus of claim 9, wherein the transmitting comprises transmitting periodic channel state information (CSI).

16. The apparatus of claim 9, wherein acknowledgement (ACK) and negative ACK (NACK) are not present.

17. An apparatus for wireless communications by a user equipment (UE), comprising:
at least one processor configured to:
determine whether a power limited condition exists; and
transmit simultaneously on multiple uplink channels or transmitting on a single uplink channel based on the determination; and
a memory coupled with the at least one processor.

18. The apparatus of claim 17, wherein the uplink channels comprise physical uplink shared channel (PUSCH) and physical uplink control channel (PUCCH).

19. The apparatus of claim 17, wherein transmitting simultaneously on multiple uplink channels or transmitting on a single uplink channel based on the determination comprises:
transmitting simultaneously on physical uplink shared channel (PUSCH) and physical uplink control channel (PUCCH) if a power limited condition does not exist; and
transmitting only on PUSCH if a power limited condition exists.

20. The apparatus of claim 19, wherein the at least one processor is further configured to:
reallocating resources allocated for transmission on the PUCCH to the PUSCH.

21. The apparatus of claim 20, wherein reallocating resources allocated to for transmission on the PUCCH to the PUSCH comprises:
reallocating one or more resource blocks (RBs) allocated from transmission on the PUCCH to the PUSCH.

22. The apparatus of claim 17, wherein determining whether a power limited condition exists comprises comparing instantaneous power headroom to a threshold.

23. The apparatus of claim 17, wherein the transmitting comprises transmitting periodic channel state information (CSI).

24. The apparatus of claim 17, wherein acknowledgement (ACK) and negative ACK (NACK) are not present.

25. A computer program product for wireless communications, comprising a computer-readable medium having instructions stored thereon, the instructions executable by an apparatus for:
determining whether a power limited condition exists; and
transmitting simultaneously on multiple uplink channels or transmitting on a single uplink channel based on the determination.

26. The computer program product of claim 25, wherein the uplink channels comprise physical uplink shared channel (PUSCH) and physical uplink control channel (PUCCH).

27. The computer program product of claim 25, wherein transmitting simultaneously on multiple uplink channels or transmitting on a single uplink channel based on the determination comprises:
transmitting simultaneously on physical uplink shared channel (PUSCH) and physical uplink control channel (PUCCH) if a power limited condition does not exist; and
transmitting only on PUSCH if a power limited condition exists.

28. The computer program product of claim 27, the instructions further executable by an apparatus for:
reallocating resources allocated for transmission on the PUCCH to the PUSCH.

29. The computer program product of claim 28, wherein reallocating resources allocated to for transmission on the PUCCH to the PUSCH comprises:
reallocating one or more resource blocks (RBs) allocated from transmission on the PUCCH to the PUSCH.

30. The computer program product of claim 25, wherein determining whether a power limited condition exists comprises comparing instantaneous power headroom to a threshold.
